(19) United States
(12) Patent Application Publication
(10) Pub. No.: US 2009/0223902 A1
(43) Pub. Date: Sep. 10, 2009

(54) Centralized Liquid Waste Treatment System and Method

(76) Inventors: Michael T. Malatesta, Brookfield, WI (US); Jeff R. Dean, Hartford, WI (US)

Correspondence Address: REINHART BOERNER VAN DEUREN S.C.;ATTN: LINDA KASULKE, DOCKET COORDINATOR, 1000 NORTH WATER STREET, SUITE 2100, MILWAUKEE, WI, 53202, US

(21) Appl. No.: 12/045,591

(22) Filed: Mar. 10, 2008

(51) Int. Cl. B01D 37/00

(52) U.S. Cl. 210/749; 210/800; 210/804; 210/209; 210/307; 210/523

(57) ABSTRACT

An integrated system for treatment of inorganic liquid waste is disclosed that quickly and efficiently processes large quantity batches of such liquid waste by initially removing solids and sludge and subsequently processing the liquid waste to remove other materials so that the processed liquid waste can be recycled in a conventional sewer system. Larger solids, sludge, and free phase oil are removed by the system before they enter the liquid waste processing equipment, thereby preventing damage to the processing equipment caused by these substances. The use of common liquid waste and sludge delivery lines on all of the contaminant removal reactors in the system facilitates the efficient operation of the system with a minimum of operator intervention being required.

### BACKGROUND OF THE INVENTION

### Field of the Invention

The present invention relates generally to treatment of inorganic liquid waste, and more particularly to an integrated system for quickly and efficiently processing large quantity batches of such liquid waste by initially removing solids and sludge and subsequently processing the liquid waste to remove other materials so that the processed liquid waste can be recycled in a conventional sewer system.

Commercial and industrial businesses, such as manufacturing operations, produce a variety of hazardous and non-hazardous waste products as a part of their normal operations. Additionally, municipalities may also produce quantities of waste, either by the operation of municipal services for the citizens, or wastes generated by the municipality's citizens. One particular type of waste that is produced by commercial, manufacturing, and municipal operations is inorganic liquid waste which frequently contains significant amounts of solids and/or sludge.

Such inorganic liquid waste products may, for example originate from water-based liquid coolants that are used in machining operations as a coolant. As the liquid coolant breaks down, it typically containing metal particles and dirt, and becomes less effective or ineffective, thereby requiring it to be disposed of. Such inorganic liquid waste products are generally not permitted to be disposed of in the sewer system, for obvious reasons of public concern due to the adverse environmental impact of such liquid waste products, as well as the necessity of complying with government regulations governing the disposal of such liquid waste products.

While such sludge-containing liquid waste products maybe transported to a location where they can be disposed of by dumping, the transportation and dumping of such sludge-containing liquid waste products is not a preferred solution. While the environmental impact of dumping can be minimized, it can not be eliminated, and hence is allowed less and less frequently. Perhaps more importantly, such sludge-containing liquid waste products may be viewed not entirely as a burden, but as a potential resource, the value of which is entirely lost by dumping.

It has increasingly been recognized that commercial, manufacturing, and municipal sludge-containing liquid waste products environmental and productivity wastes inherently contain components that may be transformed into new, valuable, and profitable resources. For example, such liquid waste products may be recycled into oil products and clean water that can be recycled. In the past, such a transformation process has been challenging. Such liquid waste products must be transported to a treatment facility that is at a remote location, typically in a large tank truck containing up to five thousand gallons or more of liquid waste products.

Once the tank truck reaches the treatment facility, it must be unloaded into a storage and/or treatment container. This has generally been done in one of two different ways, the first of which is to pressurize the tank on the truck and blow the liquid waste products into a storage tank with no prescreening being used to remove larger solids from the liquid waste products. This procedure typically takes approximately thirty to forty-five minutes to empty the tank of a five thousand gallon tank truck, assuming that there is not significant debris in the tank. Since such larger solids end up in a reactor tank and also damage pumps used to transfer the liquid waste products, those skilled in the art will at once appreciate that the debris and solid particulate matter will have a significant adverse effect on the treatment equipment, generally greatly shortening its operating life and thus significantly increasing the cost of the treatment operation.

The second way of unloading the tank of a tank truck utilizes a basket filter located between the tank of the tank truck and the container into which the liquid waste products are being transferred. While this will effectively remove larger solids from the liquid waste products, the process generally must be interrupted periodically to clean the filter basket out. Using this process, it typically takes between one hour and an hour and a half to empty the tank of a five thousand gallon tank truck. It will be appreciated by those skilled in the art that this process is both slow and labor-intensive, thereby increasing the cost of liquid waste product recycling.

It will thus be appreciated that it is desirable for a liquid waste treatment system to operate on a large scale with a minimum of human intervention being required. In this regard, such a liquid waste treatment system should be able to accept large amounts of sludge-containing liquid waste from large commercial, manufacturing, and municipal waste producers as quickly as possible. In addition, such a liquid waste treatment system should require little or no human intervention during the transfer of such liquid waste from a tank truck to the waste treatment system.

It is also desirable that larger solids and sludge be removed before they enter the liquid waste processing equipment to prevent damage caused by such larger solids and sludge to the processing equipment. It is further desirable that the liquid waste treatment system enhance the ability to easily determine when the liquid waste has been satisfactorily treated. It is also desirable that the liquid waste treatment system be adaptable to handle a variety of different types of sludge-containing liquid waste products without requiring major reconfiguration.

The centralized waste treatment system of the present invention should also be of construction which is both durable and long lasting, and it should also require relatively little maintenance to be provided by the user throughout its operating lifetime. In order to enhance the market appeal of the centralized waste treatment system of the present invention, it should also be relatively inexpensive to operate, thereby afford it the broadest possible market. Finally, it is also an objective that all of the aforesaid advantages and objectives be achieved without incurring any substantial relative disadvantage.

### SUMMARY OF THE INVENTION

The disadvantages and limitations of the background art discussed above are overcome by the present invention. The present invention provides a system and method for the sophisticated and cost-effective treatment and recycling of a wide range of liquid and sludge wastes that are not permitted into the sewer system. The present invention provides a system and method for transforming such waste produced by commercial, manufacturing and municipal operations into new, valuable and profitable resources.

The present invention may be implemented in the form of a unique, simple, proven and cost efficient inorganic liquid waste and sludge processing facility or system that is adapted to receive and treat a wide range of inorganic waste liquid and sludge. A treatment box is used to receive liquid waste transported in tank trucks and other similar liquid carrying containers. The centralized waste treatment system of the present invention allows for fast, gravity-driven unloading of liquid waste from the tank truck into a treatment box.

The treatment box has a screen box located in the treatment box for filtering out larger solids as the liquid waste is unloaded from a tank truck into the treatment box. The treatment container has a cross-sectional configuration that tapers to a narrower width at the bottom of the treatment box to direct heavier solids not filtered out by the screen box and sludge to a location near the bottom of the treatment box. An auger is located in the bottom of said treatment box to remove accumulated heavier solids not filtered out by the screen box and sludge from the treatment box.

The treatment box has an outlet located in a side thereof at a level above the level of the auger through which liquid waste contained in the treatment box can be removed for further processing. A distribution system selectively, automatically transfers liquid waste contained in the treatment box from the outlet to a selected one of multiple contaminant removal reactors for treatment therein. A chemical distribution system selectively transfers a desired amount of chemicals contained in selected ones of multiple chemical storage containers to selected contaminant removal reactors.

A decant distribution system selectively, automatically transfers processed liquid waste contained in any of the multiple contaminant removal reactors to any other of the multiple contaminant removal reactors or to a treated waste water disposal facility such as a public sewer. The decant distribution system may remove processed liquid waste from any of the multiple contaminant removal reactors from any of multiple outlets located at different levels above the bottom of the contaminant removal reactors. The centralized waste treatment system may also include apparatus for allowing the sampling of processed liquid waste contained in any of the contaminant removal reactors from any of the multiple outlets.

The centralized waste treatment system of the present invention is substantially completely automatic, relying on a remotely actuated pumps, valves, and manifold systems to move liquid waste through the system, as well as to introduce treatment chemicals to the centralized waste treatment system. The centralized waste treatment system of the present invention requires minimal operator effort, and is capable of processing an entire tank load of liquid waste at a time.

It may therefore be seen that the present invention teaches a centralized liquid waste treatment system that operates on a large scale with a minimum of human intervention being required. The centralized liquid waste treatment system is capable of rapidly accepting large amounts of sludge-containing liquid waste from large commercial, manufacturing, and municipal waste producers. In addition, the liquid waste treatment system requires little or no human intervention during the transfer of such liquid waste from a tank truck to the liquid waste treatment system.

Larger solids and sludge are removed before they enter the liquid waste processing equipment, thereby preventing damage caused by such larger solids and sludge to the processing equipment. The centralized liquid waste treatment system has an enhanced ability to easily determine when the liquid waste has been satisfactorily treated. The centralized liquid waste treatment system is also adaptable to handle a variety of different types of sludge-containing liquid waste products without requiring major reconfiguration.

The centralized waste treatment system of the present invention is of a construction which is both durable and long lasting, and which will require relatively little maintenance to be provided by the user throughout its operating lifetime. The centralized waste treatment system of the present invention is also relatively inexpensive to operate, thereby enhancing its market appeal and affording it the broadest possible market. Finally, all of the aforesaid advantages and objectives are achieved by the centralized waste treatment system of the present invention without incurring any substantial relative disadvantage.

Other aspects, objectives and advantages of the present invention will become more apparent from the following detailed description when taken in conjunction with the accompanying drawings.

### DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a flow diagram showing the method employed by the present invention to treat inorganic liquid waste;

FIG. 2 is an isometric drawing of a treatment box that contains a screen box which receives liquid waste from a tank truck;

FIG. 3 is a cross-sectional view of the treatment box and screen box illustrated in FIG. 1 taken lengthwise and showing an auger located in the bottom of the treatment box and a sludge pump located below the treatment box, as well as the location at which liquid waste is drained from the treatment box;

FIG. 4 is a cross-sectional view of the treatment box and screen box illustrated in FIG. 1 taken across the width thereof, showing the tapering configuration of the treatment box;

FIG. 5 is a somewhat schematic depiction of the removal of sludge from the auger of the treatment box illustrated in FIGS. 1 through 3 as well as the subsequent treatment of the sludge;

FIG. 6 is a somewhat schematic depiction of the path of the liquid waste between the treatment box and one of multiple contaminant removal reactors or an oil cracking reactor;

FIG. 7 is a schematic depiction of the path of the liquid waste and treatment chemicals into a primary contaminant removal reactor, as well as the path of the liquid waste from the primary contaminant removal reactor to a secondary contaminant removal reactor, the path of treatment chemicals into the secondary contaminant removal reactor, and the path of the liquid waste from the secondary contaminant removal reactor; and

FIG. 8 is a schematic depiction of the path of the treatment chemicals from storage tanks therefor to primary contaminant removal reactors and secondary contaminant removal reactors.

While the centralized waste treatment system of the present invention will be described in connection with certain exemplary embodiments shown in the figures, there is no intent to limit it to those embodiments. On the contrary, the intent is to cover all alternatives, modifications, and equivalents that are included within the spirit and scope of the invention as defined by the appended claims.

### DETAILED DESCRIPTION OF THE EXEMPLARY EMBODIMENTS

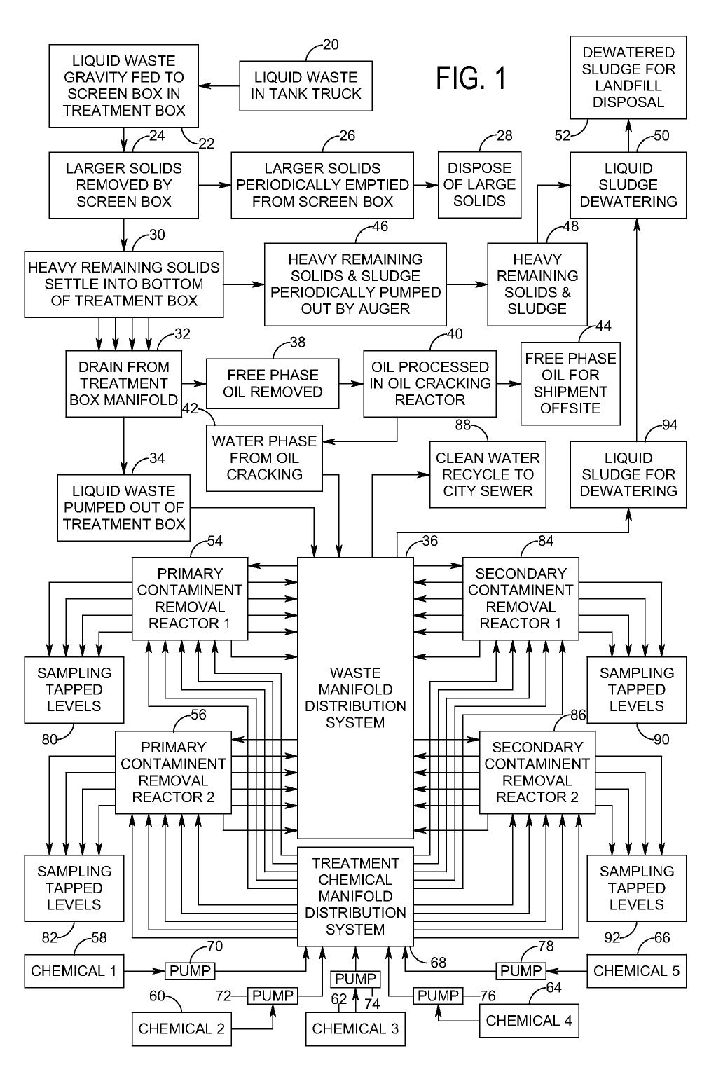

An exemplary embodiment of the centralized waste treatment system of the present invention is schematically depicted in FIG. 1. Inorganic liquid waste may be delivered to the centralized waste treatment system of the present invention in a tank truck, as shown in a liquid waste in tank truck step 20. Typically, the tank truck may contain up to five thousand gallons of liquid waste. The liquid waste is gravity fed to a screen box that is contained in the treatment box in a liquid waste gravity fed to screen box in treatment box step 22.

As the liquid waste enters the screen box, larger solids are removed by the screen box in a larger solids removed by screen box step 24. Periodically, the larger solids collected in the screen box are emptied from the screen box in a larger solids emptied from screen box step 26. The larger solids 28 are disposed of in a dispose of large solids step 28.

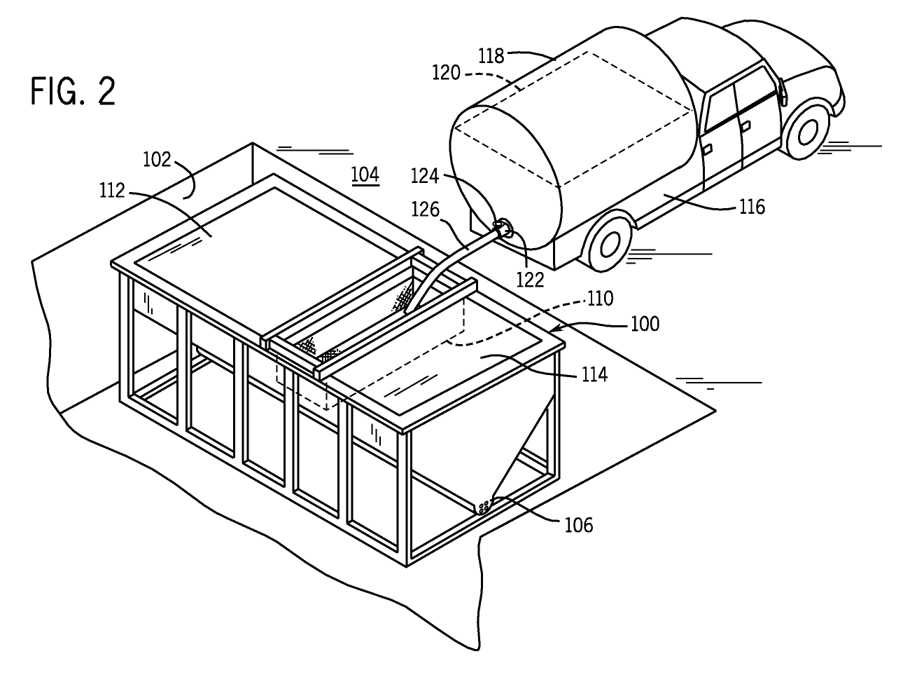

The liquid waste without the removed large solids flows through the screen box into the treatment box, where remaining heavy solids settle onto the bottom of the treatment box in a heavy remaining solids settle into bottom of treatment box step 30. Liquid sludge will also tend to settle to the bottom of the treatment box. The design of the treatment box, which enhances this occurrence, will be discussed below in conjunction with FIGS. 2 through 4.

The liquid waste is taken from the treatment box at a level above the bottom of the treatment box, thereby allowing any heavy remaining solids and liquid sludge to remain in the bottom of the treatment box through a drain from treatment box manifold step 32. Liquid waste is pumped out of the treatment box through the treatment box manifold in a liquid waste pumped out of treatment box step 34. Except as otherwise discussed below, the liquid waste is pumped from the treatment box to a waste manifold distribution system 36.

Depending upon the liquid waste contained in the treatment box, there may be free phase oil floating on the top of the rest of the liquid waste in the treatment box. Using the treatment box manifold, this free phase oil may be removed separately from the rest of the liquid waste. By first pumping the rest of the liquid waste from the treatment box until the level of liquids in the treatment box has dropped sufficiently to leave only the free phase oil above the level of the outlet at which the liquid waste is removed from the treatment box, the free phase oil can be removed from the box in a free phase oil removed step 38. Alternately, by having the treatment box manifold having multiple levels from which liquid waste can be removed from the treatment box, the free phase oil can be drained off of the top of the remaining liquid waste in the treatment box.

The free phase oil is processed in an oil cracking reactor in an oil processed in oil processing reactor step 40. In this processing, water and free phase oil are produced, with the water being provided in a water phase from oil cracking step 42 to the waste manifold distribution system 36 with the other liquid waste from the liquid waste pumped out of treatment box step 34. The free phase oil may be stored and shipped offsite for recycling in a free phase oil for shipment offsite step 44.

Following removal of substantially all of the liquid waste and free phase oil contained in the treatment box at or above the level of the treatment box manifold, there may be sufficient heavy remaining solids and liquid sludge remaining in the bottom of the treatment box to require their removal. If so, in a heavy remaining solids and sludge periodically pumped out by auger step 46, the heavy remaining solids and liquid sludge 48 are pumped out of the treatment box by the auger in the bottom of the treatment box. The heavy remaining solids and liquid sludge 48 are solidified in a liquid sludge dewatering step 50, typically by adding sawdust or some other similar material to the heavy remaining solids and liquid sludge 48. The dewatered sludge can then be disposed of in a landfill in a dewatered sludge for landfill disposal step 52.

The liquid waste, which has by now had large solids, heavy remaining solids, sludge, and free phase oil removed therefrom, is distributed by the waste manifold distribution system 36 to a plurality of contaminant removal reactors. The number of contaminant removal reactors will be dictated by the volume of liquid waste to be processed, but all of the contaminant removal reactors are linked together with the waste manifold distribution system 36. Typically, treatment of the liquid waste is a two-step process, with a primary contaminant removal reactor being used first, and with the processed liquid waste from the primary contaminant removal reactor then being processed again in a secondary contaminant removal reactor. In the centralized waste treatment system illustrated in FIG. 1, two primary contaminant removal reactors and two secondary contaminant removal reactors are shown.

Liquid waste is initially selectively supplied to either or both of a first primary contaminant removal reactor 54 and a second primary contaminant removal reactor 56 through the waste manifold distribution system 36. Chemicals from five chemical storage containers 58, 60, 62, 64, and 66 are used to process the liquid waste in the contaminant removal reactors. The five chemical storage containers 58, 60, 62, 64, and 66 are pumped to a treatment chemical manifold distribution system 68 by five metering pumps 70, 72, 74, 76, and 78, respectively. The waste manifold distribution system 36 selectively, sequentially directs chemicals from the chemical storage containers 58, 60, 62, 64, and 66 to the first contaminant removal reactor 54 and the second contaminant removal reactor 56.

Following treatment in the first primary contaminant removal reactor 54 or the second primary contaminant removal reactor 56, liquid waste may be sampled to determine the effectiveness of the treatment process at any of several different levels in the first primary contaminant removal reactor 54 or the second primary contaminant removal reactor 56. Thus, the processed liquid waste may be sampled in the first primary contaminant removal reactor 54 in a sampling tapped levels step 80, and the processed liquid waste in the second primary contaminant removal reactor 56 may be sampled in a sampling tapped levels step 82. These sampling tapped levels steps 80 and 82 enable an operator to determine the effectiveness of the treatment process on the liquid waste, as well as to determine when it is necessary to add chemicals from the chemical storage containers 58, 60, 62, 64, and 66.

The sampling tapped levels steps 80 and 82 also enable an operator to selectively sample the treated liquid waste at different levels, and the operator can determine at which level the processed liquid waste may be removed from the first primary contaminant removal reactor 54 or the second primary contaminant removal reactor 56 for subsequent processing in a selected one of a first secondary contaminant removal reactor 84 and a second secondary contaminant removal reactor 86. Alternately, if the treated liquid waste in the first primary contaminant removal reactor 54 or the second primary contaminant removal reactor 56 has been sufficiently treated, it could be recycled through the waste manifold distribution system 36 to a city sewer or similar cleaned waste water disposal facility in a clean water to city sewer step 88.

More typically, following treatment in the first primary contaminant removal reactor 54 or the second primary contaminant removal reactor 56, partially treated liquid waste is removed from the first primary contaminant removal reactor 54 or the second primary contaminant removal reactor 56 through the waste manifold distribution system 36 and is directed for subsequent processing to a selected one of the first secondary contaminant removal reactor 84 and the second secondary contaminant removal reactor 86. The waste manifold distribution system 36 selectively, sequentially directs chemicals from the chemical storage containers 58, 60, 62, 64, and 66 to the first secondary contaminant removal reactor 84 and the second secondary contaminant removal reactor 86.

Following treatment in the first secondary contaminant removal reactor 84 or the second secondary contaminant removal reactor 86, the liquid waste may be sampled to determine the effectiveness of the treatment process at any of several different levels in the first secondary contaminant removal reactor 84 or the second secondary contaminant removal reactor 86 Thus, the processed liquid waste may be sampled in the first secondary contaminant removal reactor 84 in a sampling tapped levels step 90, and the processed liquid waste in the second secondary contaminant removal reactor 86 may be sampled in a sampling tapped levels step 92. These sampling tapped levels steps 80 and 82 enable the operator to determine the effectiveness of the treatment process on the liquid waste, as well as to determine when it is necessary to add chemicals from the chemical storage containers 58, 60, 62, 64, and 66.

The sampling tapped levels steps 90 and 92 enable the operator to selectively sample the treated liquid waste at different levels, and the operator can determine at which level the processed liquid waste may be removed from the first secondary contaminant removal reactor 84 or the second secondary contaminant removal reactor 86 for recycling through the waste manifold distribution system 36 to the city sewer or similar cleaned waste water disposal facility in the clean water to city sewer step 88.

By removing the treated waste water from the first primary contaminant removal reactor 54, the second primary contaminant removal reactor 56, the first secondary contaminant removal reactor 84, and the second secondary contaminant removal reactor 86, liquid sludge and solids contained therein are left behind for later removal through the waste manifold distribution system 36 in a liquid sludge for dewatering step 94. The liquid sludge and solids contained therein are solidified in the liquid sludge dewatering step 50, with the dewatered sludge then being disposed of in a landfill in the dewatered sludge for landfill disposal step 52.

The centralized waste treatment system discussed above in conjunction with FIG. 1 will now be discussed in conjunction with drawings of portions of that system in FIGS. 2 through 8. Referring first to FIGS. 2 through 4, a treatment box 100 is shown installed in a pit 102 located in a floor surface 104, as best shown in FIG. 2. The top of the treatment box 100 is preferably installed in the pit 102 with the top of the treatment box 100 being essentially level with or slightly below the level of the floor surface 104, thereby allowing for complete gravity emptying of most common liquid waste or sludge waste transportation trucks into the treatment box 100. The pit 102 is preferably sized to accommodate the treatment box 100 with access space located on at least several of the sides thereof.

Incoming liquid and sludge waste is delivered into the centralized waste treatment system of the present invention via the treatment box 100, which may be thought of as an unloading container or tank that is designed to receive incoming waste from tank trucks or other liquid waste or sludge waste delivery or transportation containers or vehicles. The facility employing the centralized waste treatment system of the present invention may feature a plurality of truck or other container unloading bays, each of which may have a treatment box 100, thereby allowing multiple trucks or other containers to unload transported liquid waste or sludge waste simultaneously.

The treatment box 100 is preferably a steel container, although another appropriate metal or other material may be used to fabricate the treatment box 100. The interior of the treatment box 100 could be equipped with a painted or plastic liner, if desired. In the exemplary embodiment shown in FIGS. 2 through 4, the treatment box 100 measures approximately twenty feet long, eight feet wide, and six feet tall, and has a capacity of approximately five thousand gallons. Other dimensions and capacities may also be utilized, depending, for example, on the capacity or other characteristics of the trucks or other containers whose waste contents are to be emptied into the treatment box 100.

The treatment box 100 of the exemplary embodiment shown in FIGS. 1 through 4 has a rectangular configuration from the top edge thereof to approximately the vertical center of the side of the treatment box 100 (i.e., approximately two feet down from the top edge of the treatment box 100), and then tapers to a narrower width such that it is substantially V-shaped in longitudinal cross-section from this point to the bottom of the treatment box 100, as best shown in FIG. 4. Located at the bottom of the V-shaped portion of the treatment box 100 is a longitudinally-extending conveyer recess 106 which is U-shaped in longitudinal cross-section. An auger 108 is positioned within and extends along the length of the conveyer recess 106.

Located in the treatment box 100 is a screen box 110 that is approximately seven feet long, four feet wide, and two feet deep. The screen box 110 is open on its top side, and consists of a mesh screen on all of its other sides. The screen box 110 may be made of stainless steel, or any other appropriate material. The screen box 110 has a mesh size that is suitable to prevent larger solids and other unwanted debris from entering the treatment box 100 while not slowing the filling of liquid waste into the treatment box 100. The mesh size may be varied depending upon the particular type and size of larger solids and other unwanted debris that are typically contained in the liquid waste products being treated. When liquid waste is placed into the treatment box 100, it will be placed into the screen box 110 to remove the large solids from the liquid waste. The top of the treatment box 100 other than the location of the screen box 110 may be enclosed by cover members 112 and 114.

Liquid waste may be filled into the treatment box 100 from a tank truck 116 having a tank 118 that is filled with liquid waste 120. The tank 118 has an outlet 122 with a valve 124. A fill hose 126 has one end thereof secured to the outlet 122 and the other end located in the screen box 110 in the treatment box 100. The valve 124 is opened (and preferably the tank 118 is vented) to allow the liquid waste 120 to be drained by gravity from the tank 118 to the treatment box 100.

As the liquid waste 120 flows into the screen box 110, larger solids and other unwanted debris contained in the liquid waste 120 are filtered out by the screen box 110. Such larger solids and other unwanted debris may be periodically removed from the screen box 110 and recycled or otherwise disposed of. Using the centralized waste treatment system of the present invention, a tanker load (up to five thousand gallons) of liquid waste can be gravity-filled from the tank truck 116 to the treatment box 100 in less than ten minutes. This compares favorably to conventional systems in use today that require an between one half hour and one hour to complete the same task.

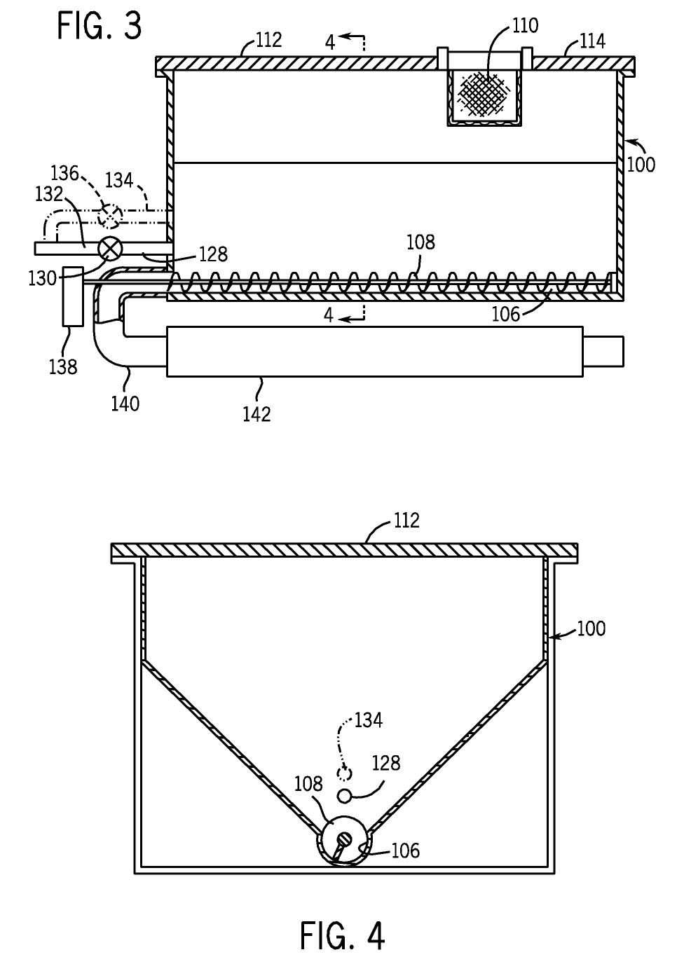

When liquid waste is filled into the treatment box 100, heavier solids and sludge will tend to rapidly settle onto the bottom of the treatment box 100, including within the conveyer recess 106 and around the auger 108. When the liquid waste is taken out of the treatment box 100 for further processing, it is taken out at a level sufficiently far above the bottom of the treatment box 100 to prevent the heavier solids and the sludge from being taken out with the liquid waste. The location of an outlet 128 at an end of the treatment box 100 is shown in FIGS. 3 and 4. The egress of liquid waste from the treatment box 100 is controlled by a valve 130 on the outlet 128, with a liquid waste outlet manifold 132 being located on the opposite side of the valve 130 from the outlet 128.

Optionally, it may be desirable to have more than a single outlet from the screen box 110, with one or more additional outlets being located at different heights. One such additional outlet 134 is shown in FIGS. 3 and 4, with an additional valve 136 being used on the additional outlet 134 to control the egress of liquid waste from the additional outlet 134 to the liquid waste outlet manifold 132.

By carefully controlling the egress of liquid waste from the treatment box 100, only liquid waste, and not the heavier solids and sludge, may be taken for further processing. Also, if there is a layer of free phase oil floating on the top of the liquid waste, this may be removed separately for processing in the oil processed in an oil processing reactor (as discussed above in conjunction with FIG. 1).

Returning to the auger 108, it is preferably made of steel or another appropriate material, and in the example discussed herein it is approximately sixteen inches in diameter and is sized to fit the conveyer recess 106. Other sizes may be used for the auger 108 and the conveyer recess 106 depending upon the type and volume of liquid waste to be transported by the auger 108. The auger 108 is driven by a motor drive 138, such as a Dodge drive, although any appropriate auger drive for the auger 108 being driven and the type and volume of heavier solids and sludge to be moved thereby may be used.

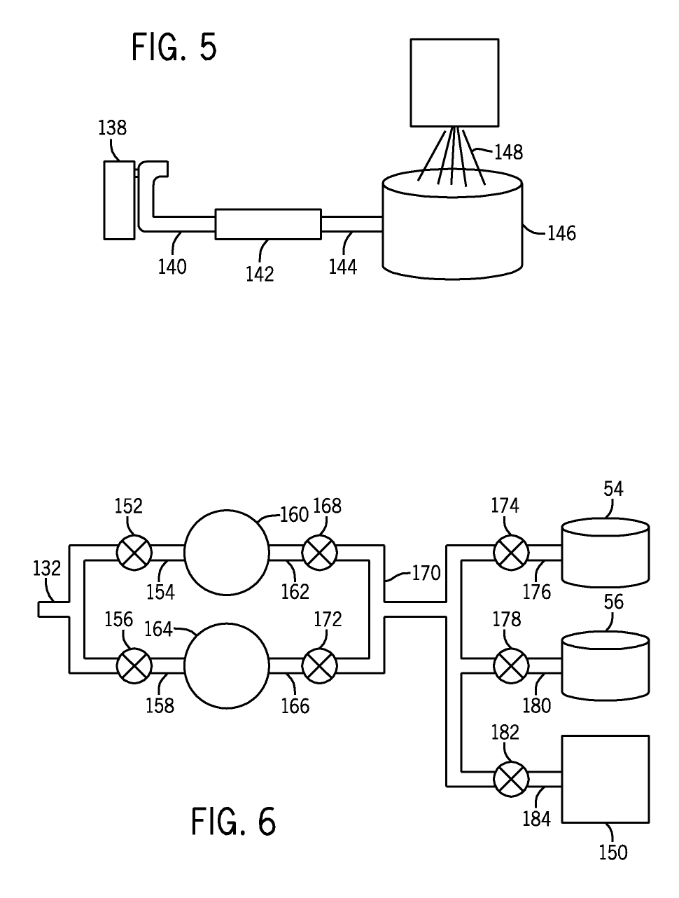

Referring now to FIG. 5 in addition to FIG. 3, the auger 108 conveys the heavier solids and sludge through a manifold 140 to a progressive cavity pump 142 installed on the outlet end of the manifold 140. Any progressive cavity pump appropriate for the type and desired volume of the heavier solids and sludge to be pumped may be used, such as, for example, a progressive cavity pump with a steel casing and a stainless steel worm gear powered by a thirty horsepower electrical motor. The progressive cavity pump 142 conveys heavier solids and sludge that collect in the conveyer recess 106 of the treatment box 100 from the treatment box 100 through a sludge delivery line 144 to a solidification pit 146 where the heavier solids and sludge can be dewatered, typically by adding an absorptive particulate additive 148 such as sawdust or to solidify the heavier solids and sludge. The solidified heavier solids and sludge may then be taken to a landfill (not shown herein) for disposal.

Referring next to FIG. 6, the path of liquid waste from the liquid waste outlet manifold 132 (also shown in FIG. 3) to the first primary contaminant removal reactor 54, the second primary contaminant removal reactor 56, and an oil cracking reactor 150 is illustrated. A valve 152 is located between the liquid waste outlet manifold 132 and a first pump inlet 154, and a valve 156 is located between the liquid waste outlet manifold 132 and a second pump inlet 158. The first and second pumps 160 and 164 are used to provide redundancy in the event that one of them has a problem.

The first pump inlet 154 is connected to a first pump 160, the other side of which is connected to a first pump outlet 162, and the second pump inlet 158 is connected to a second pump 164, the other side of which is connected to a second pump outlet 166. The first pump outlet 162 is connected to one side of a valve 168, the other side of which is connected to a supply manifold 170. The second pump outlet 166 is connected to one side of a valve 172, the other side of which is connected to the supply manifold 170. The supply manifold 170 supplies liquid waste to the first primary contaminant removal reactor 54, the second primary contaminant removal reactor 56, and the oil cracking reactor 150, as well as to any additional primary contaminant removal reactors contained in the centralized waste treatment system.

A valve 174 is located between the supply manifold 170 and one end of a first primary reactor inlet 176, the other end of which supplies liquid waste to the first primary contaminant removal reactor 54. A valve 178 is located between the supply manifold 170 and one end of a second primary reactor inlet 180, the other end of which supplies liquid waste to the second primary contaminant removal reactor 56. A valve 182 is located between the supply manifold 170 and one end of an oil cracking reservoir inlet 184, the other end of which is capable of supplying free phase oil to the oil cracking reactor 150 (when free phase oil is being pumped from the supply manifold 170).

The apparatus shown in FIG. 6 and used to provide liquid waste from the treatment box 100 (shown in FIGS. 1 through 4) to the first primary contaminant removal reactor 54, the second primary contaminant removal reactor 56, and the oil cracking reactor 150 comprises a portion of the waste manifold distribution system 36 (shown in FIG. 1). The valves in the centralized waste treatment system of the present invention are controlled by an operator, and they may be actuated to selectively pump liquid waste from the treatment box 100 (or from additional treatment boxes if the system has them) to the first primary contaminant removal reactor 54 or the second primary contaminant removal reactor 56 (or to any other primary reactors in the system), as well as to selectively pump free phase oil from the treatment box 100 to the oil cracking reactor 150.

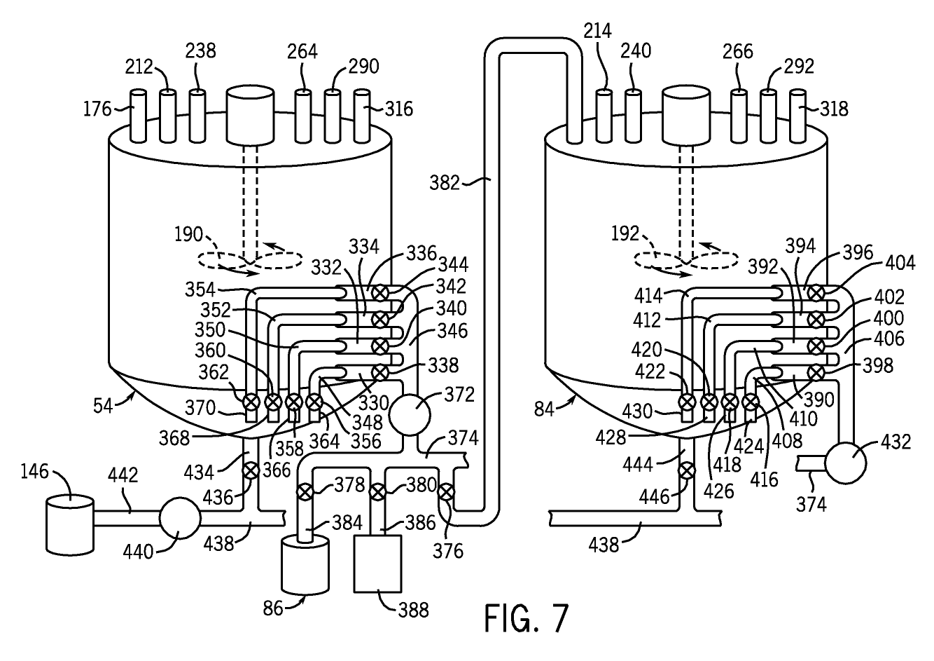

The valves may be air operated actuator valves or any other type of valve suitable for use in the centralized waste treatment system. An automated selection panel (not shown) is used to control the actuation of the valves. When the operator selects which contaminant removal reactor to receive the liquid waste, the actuator opens the valves on each side of a pump as well as the valve leading to the inlet on the top of the selected contaminant removal reactor (see the location of the first primary reactor inlet 176 on the first primary contaminant removal reactor 54 in FIG. 7), thereby allowing the waste to be pumped into the selected contaminant removal reactor. During this event, the rest of the valves in the centralized waste treatment system remain closed, preventing waste from entering any contaminant removal reactor other than the one selected by the operator.

If desired, any liquid waste remaining in the pipeline is a concern, the incoming pipeline can be equipped with an air chuck that allows for air to enter the pipeline and blow all remaining liquid waste into the selected contaminant removal reactor. The centralized waste treatment system of the present invention can pump the contents of the treatment box 100 to a desired contaminant removal reactor for treatment in approximately ten to fifteen minutes.

Referring next to FIG. 7, the first primary contaminant removal reactor 54 and the first secondary contaminant removal reactor 84 are shown. The contaminant removal reactors used in the centralized waste treatment system of the present invention are basically of a conventional design, and preferably have cone shaped bottoms, which promote good sludge separation after treatment and makes it easier to wash out the contaminant removal reactors. Preferably, the contaminant removal reactor tanks are made of a transparent or semi-transparent plastic material, such as polyethylene, which allows the level of liquid waste contained in each contaminant removal reactor to be easily viewed, thereby obviating the need for expensive and potentially unreliable mechanical and/or electrical level indicators.

The contaminant removal reactors preferably provide sufficient capacity for accommodating the capacity of a tank truck plus the addition of treatment chemicals (and also taking into account the possibility of foaming during treatment). For example, a seven thousand four hundred gallon contaminant removal reactor tank typically will provide sufficient capacity for the complete unloading and treatment of liquid waste from most tank trucks. The contaminant removal reactors preferably are equipped with appropriate mixers (mixers 190 and 192 are respectively shown in the first primary contaminant removal reactor 54 and the first secondary contaminant removal reactor 84) to provide the mixing necessary for complete chemical/waste blending and sludge flocculation. Such mixers may include mechanical mixers and/or mixers employing pressurized air or other fluids. An exemplary preferred mixer that may be employed for each contaminant removal reactor is the Series 10 Lightnin' Mixer.

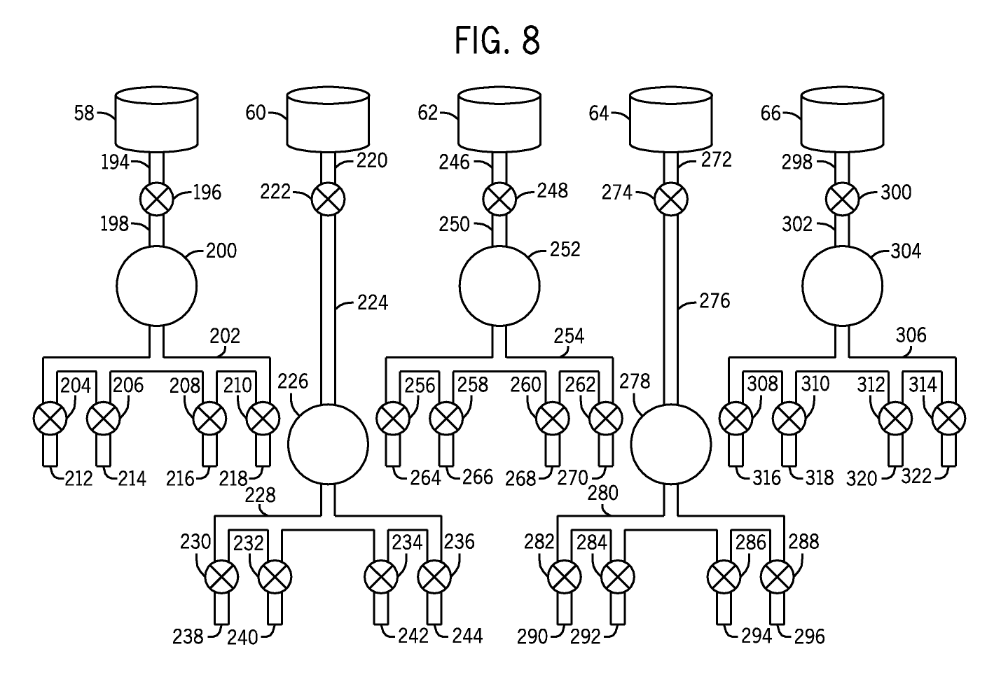

Referring now to FIG. 8 in addition to FIG. 7, the distribution of treatment chemicals to the contaminant removal reactors is illustrated. Each of the five chemicals respectively contained in the first chemical storage container 58, the second chemical storage container 60, and the third chemical storage container 62, the fourth chemical storage container 64, and the fifth chemical storage container 64 includes its own chemical distribution pipeline, each of the five pipelines thus being dedicated to the distribution of a single treatment chemical. The five chemical distribution pipelines collectively comprise the treatment chemical manifold distribution system 68 (shown in FIG. 1).

The chemical distribution pipelines are designed for ease of use and operation. The chemical distribution pipelines preferably are made of an appropriate pipe size and material for the volume and type of chemicals to be distributed thereby. For example, a series of one inch pipelines of schedule 80 polyvinylchloride (PVC) may be used (schedule 80 PVC is used for its chemical durability, ease of assembly, and maintenance flexibility). Each chemical distribution pipeline includes a metering pump for precise delivery of the desired amounts of the chemicals to the desired contaminant removal reactor.

The first chemical storage container 58 has an outlet 194 that is connected to one side of a valve 196, the other side of which is connected to a pump inlet 198 of a pump 200. The outlet of the pump 200 is a first chemical manifold 202. Four valves 204, 206, 208, and 210 are located between the first chemical manifold 202 and one end of four chemical reactor inlets 212, 214, 216, and 218, respectively, the other ends of which first chemical reactor inlets 212, 214, 216, and 218 respectively supply the first chemical to the first primary contaminant removal reactor 54, the second primary contaminant removal reactor 56, the first secondary contaminant removal reactor 84, and the second secondary contaminant removal reactor 86.

The second chemical storage container 60 has an outlet 220 that is connected to one side of a valve 222, the other side of which is connected to a pump inlet 224 of a pump 226. The outlet of the pump 226 is a second chemical manifold 228. Four valves 230, 232, 234, and 236 are located between the second chemical manifold 228 and one end of four second chemical reactor inlets 238, 240, 242, and 244, respectively, the other ends of which second chemical reactor inlets 238, 240, 242, and 244 respectively supply the second chemical to the first primary contaminant removal reactor 54, the second primary contaminant removal reactor 56, the first secondary contaminant removal reactor 84, and the second secondary contaminant removal reactor 86.

The third chemical storage container 62 has an outlet 246 that is connected to one side of a valve 248, the other side of which is connected to a pump inlet 250 of a pump 252. The outlet of the pump 252 is a third chemical manifold 254. Four valves 256, 258, 260, and 262 are located between the third chemical manifold 254 and one end of four third chemical reactor inlets 264, 266, 268, and 270, respectively, the other ends of which third chemical reactor inlets 264, 266, 268, and 270 respectively supply the third chemical to the first primary contaminant removal reactor 54, the second primary contaminant removal reactor 56, the first secondary contaminant removal reactor 84, and the second secondary contaminant removal reactor 86.

The fourth chemical storage container 64 has an outlet 272 that is connected to one side of a valve 274, the other side of which is connected to a pump inlet 276 of a pump 278. The outlet of the pump 278 is a fourth chemical manifold 280. Four valves 282, 284, 286, and 288 are located between the fourth chemical manifold 280 and one end of four fourth chemical reactor inlets 290, 292, 294, and 296, respectively, the other ends of which fourth chemical reactor inlets 290, 292, 294, and 296 respectively supply the fourth chemical to the first primary contaminant removal reactor 54, the second primary contaminant removal reactor 56, the first secondary contaminant removal reactor 84, and the second secondary contaminant removal reactor 86.

The fifth chemical storage container 66 has an outlet 298 that is connected to one side of a valve 300, the other side of which is connected to a pump inlet 302 of a pump 304. The outlet of the pump 304 is a fifth chemical manifold 306. Four valves 308, 310, 312, and 314 are located between the fifth chemical manifold 306 and one end of four fifth chemical reactor inlets 316, 318, 320, and 322, respectively, the other ends of which fifth chemical reactor inlets 316, 318, 320, and 322 respectively supply the fifth chemical to the first primary contaminant removal reactor 54, the second primary contaminant removal reactor 56, the first secondary contaminant removal reactor 84, and the second secondary contaminant removal reactor 86.

Each of the five chemical distribution pipelines has termination points at the top of each of the contaminant removal reactors. The valves connected to the reactor inlets are preferably provided at or near the point at which each chemical distribution pipeline provides the chemical to each of the contaminant removal reactors. The chemical dispensing is automated, and the valves may be manual or they may again be air operated actuator valves or any other type of suitable valves. This design reduces the likelihood of an operator coming in contact with splashing chemical.

The automated selection panel (not shown) is used to control the actuation of these valves as well. When the operator selects which chemical is to be delivered to which contaminant removal reactor, the actuator opens the valve located between the chemical storage tank and the pump as well as the valve leading to the inlet on the top of the selected contaminant removal reactor (see the location of the chemical reactor inlet 212, 238, 264, 290, and 316 on the first primary contaminant removal reactor 54 in FIG. 7), thereby allowing the desired chemical to be pumped into the selected contaminant removal reactor. During this event, the rest of the valves in the chemical delivery system remain closed. All liquid chemicals are dispensed into the reactor in the same manner until the desired treatment formula is met.

Chemicals typically used in the treatment process in contaminant removal reactors may include caustic soda liquid (sodium hydroxide), alum (aluminum sulfate), polymer (anionic or cationic), ferric chloride, and sulfuric acid. The process typically is initiated on liquid waste contained in a contaminant removal reactor by increasing the pH by adding caustic soda liquid while mixing. Next, alum is added while mixing to destabilize ions in the liquid waste. The polymer is then added while mixing, and the mixing is stopped.

Low solid sludge will start to fall out of solution, moving toward the bottom of the contaminant removal reactor. The liquid waste then can be tested (the apparatus used to obtain a sample will be discussed below), and if there is too much inorganic contamination (typically from metal), ferric chloride is added to treat the waste (after increasing the pH if necessary by adding more caustic soda). Sulfuric acid is added only as needed to lower the pH.

Referring now to FIG. 7, the apparatus used to both sample the treated liquid waste and to remove the treated liquid waste from the contaminant removal reactors is shown. The first primary contaminant removal reactor 54 has four outlets 330, 332, 334, and 336 that are located at four different heights in the first primary contaminant removal reactor 54. Each of the outlets 330, 332, 334, and 336 is respectively connected to one side of four valves 338, 340, 342, and 344, the other side of which valves 338, 340, 342, and 344 are connected to an outlet manifold 346.

Each of the outlets 330, 332, 334, and 336 is also respectively connected to one end of four tap lines 348, 350, 352, and 354, the other ends of which tap lines 348, 350, 352, and 354 are respectively connected to four tap valves 356, 358, 360, and 362 on one side thereof. The other sides of the tap valves 356, 358, 360, and 362 are respectively connected to four tap outlets 364, 366, 368, 370. Using the tap valves 356, 358, 360, and 362, the treated liquid waste contained in the first primary contaminant removal reactor 54 can be sampled through the tap outlets 364, 366, 368, 370 at any of the levels at which the outlets 330, 332, 334, and 336 are located.

Similarly, the treated liquid waste contained in the first primary contaminant removal reactor 54 can be drained through the outlet manifold 346 at any of the levels at which the outlets 330, 332, 334, and 336 are located by opening the appropriate one of the valves 338, 340, 342, and 344. A pump 372 may be connected between the outlet manifold 346 and a decant pipeline 374, which is shown as having three outlets respectively connected to the valves 376, 378, and 380. The valve 376 is connected to one end of a first secondary reactor inlet 382 through which treated liquid waste from the first primary contaminant removal reactor 54 can be supplied to the first secondary contaminant removal reactor 84.

The valve 378 is connected to one end of a second secondary reactor inlet 384 through which treated liquid waste from the first primary contaminant removal reactor 54 can be supplied to the second secondary contaminant removal reactor 86. Processing similar to the processing described above may be performed in the first secondary contaminant removal reactor 84, usually with the goal of producing liquid waste that has been found to be sufficiently treated to be disposed of in a public sewer or the like. The valve 380 is connected to a treated liquid waste delivery line 386 through which treated liquid waste that has been found to be sufficiently treated can be supplied to a public sewer 388 or the like.

The first secondary contaminant removal reactor 84 has outlets and taps that are identical to those described above on the first primary contaminant removal reactor 54. The first secondary contaminant removal reactor 84 has four outlets 390, 392, 394, and 396 that are located at four different heights in the first secondary contaminant removal reactor 84. Each of the outlets 390, 392, 394, and 396 is respectively connected to one side of four valves 398, 400, 402, and 404, the other side of which valves 398, 400, 402, and 404 are connected to an outlet manifold 406.

Each of the outlets 390, 392, 394, and 396 is also respectively connected to one end of four tap lines 408, 410, 412, and 414, the other ends of which tap lines 408, 410, 412, and 414 are respectively connected to four tap valves 416, 418, 420, and 422 on one side thereof. The other sides of the tap valves 416, 418, 420, and 422 are respectively connected to four tap outlets 424, 426, 428, 430. Using the tap valves 416, 418, 420, and 422, the treated liquid waste contained in the first secondary contaminant removal reactor 84 can be sampled through the tap outlets 424, 426, 428, 430 at any of the levels at which the outlets 390, 392, 394, and 396 are located.

The treated liquid waste contained in the first secondary contaminant removal reactor 84 can be drained through the outlet manifold 406 at any of the levels at which the outlets 390, 392, 394, and 396 are located by opening the appropriate one of the valves 398, 400, 402, and 404. A pump 432 may be connected between the outlet manifold 406 and the decant pipeline 374. Liquid waste from the first secondary contaminant removal reactor 84 is typically sufficiently treated to be disposed of in the public sewer 388 or the like. The valve 380 is used to provide the treated liquid waste to the treated liquid waste delivery line 386, which channels it to the public sewer 388 or the like.

Liquid sludge is typically removed from the contaminant removal reactors at the bottom thereof. The first primary contaminant removal reactor 54 has a sludge outlet 434 located at the bottom thereof. A valve 436 is located between the sludge outlet 434 and a sludge pipeline 438. A pump 440 is used to pump liquid sludge from the sludge pipeline 438 to a sludge delivery line 442 which leads to the solidification pit 146. Similarly, the first secondary contaminant removal reactor 84 has a sludge outlet 444 located at the bottom thereof, with a valve 446 being located between the sludge outlet 444 and the sludge pipeline 438.

It will be appreciated that the use of the decant pipeline 374 and the sludge pipeline 438 with regard to all of the contaminant removal reactors in the centralized waste treatment system of the present invention leads to a tremendous degree of flexibility in the operation of the centralized waste treatment system. Liquid waste can be pumped between any of the contaminant removal reactors, with an entire tank load of liquid waste being processed at a time. Also, the use of the various valves and motors allows a single operator to control the entire system in a highly efficient manner.

It may therefore be appreciated from the above detailed description of the exemplary embodiments of the present invention that it teaches a centralized liquid waste treatment system that operates on a large scale with a minimum of operator intervention being required. The centralized liquid waste treatment system is capable of rapidly accepting large amounts of sludge-containing liquid waste from large commercial, manufacturing, and municipal waste producers. In addition, the liquid waste treatment system requires little or no human intervention during the transfer of such liquid waste from a tank truck to the liquid waste treatment system.

Larger solids and sludge are removed before they enter the liquid waste processing equipment, thereby preventing damage caused by such larger solids and sludge to the processing equipment. The centralized liquid waste treatment system has an enhanced ability to easily determine when the liquid waste has been satisfactorily treated. The centralized liquid waste treatment system is also adaptable to handle a variety of different types of sludge-containing liquid waste products without requiring major reconfiguration.

The centralized waste treatment system of the present invention is of a construction which is both durable and long lasting, and which will require relatively little maintenance to be provided by the user throughout its operating lifetime. The centralized waste treatment system of the present invention is also relatively inexpensive to operate, thereby enhancing its market appeal and affording it the broadest possible market. Finally, all of the aforesaid advantages and objectives are achieved by the centralized waste treatment system of the present invention without incurring any substantial relative disadvantage.

Although the foregoing description of the centralized waste treatment system of the present invention has been shown and described with reference to particular embodiments and applications thereof, it has been presented for purposes of illustration and description and is not intended to be exhaustive or to limit the invention to the particular embodiments and applications disclosed. It will be apparent to those having ordinary skill in the art that a number of changes, modifications, variations, or alterations to the invention as described herein may be made, none of which depart from the spirit or scope of the present invention. The particular embodiments and applications were chosen and described to provide the best illustration of the principles of the invention and its practical application to thereby enable one of ordinary skill in the art to utilize the invention in various embodiments and with various modifications as are suited to the particular use contemplated. All such changes, modifications, variations, and alterations should therefore be seen as being within the scope of the present invention as determined by the appended claims when interpreted in accordance with the breadth to which they are fairly, legally, and equitably entitled.

What is claimed is:

1. A waste treatment system for treating inorganic liquid waste, said system comprising:
a treatment container for receiving liquid waste unloaded from a tank truck, said treatment container having sides and a bottom;
a screen box located in said treatment container for filtering out larger solids as the liquid waste is unloaded from a tank truck into said treatment container;
an auger located in said bottom of said treatment container, said treatment container being arranged and configured such that heavier solids not filtered out by said screen box and sludge are directed to a location near said auger in said bottom of said treatment container as they are acted upon by gravity, said auger being operable to remove accumulated solids and sludge from said treatment container;
an outlet located in a side of said treatment container at a level above the level of said auger through which liquid waste contained in said treatment container can be removed for further processing; and
at least one contaminant removal reactor for receiving liquid waste removed from said treatment container and for treating the liquid waste therein.

2. A waste treatment system as defined in claim 1, wherein said treatment container has a cross-sectional configuration which tapers to a narrower width at the location of said auger in said treatment container to direct heavier solids not filtered out by said screen box and sludge to a location near said auger.

3. A waste treatment system as defined in claim 1, wherein said treatment container is sufficiently large to accommodate the liquid waste contents of an entire tank truck therein.

4. A waste treatment system as defined in claim 1, wherein said treatment container is recessed such that the top of said treatment container is located at or below ground level to facilitate gravity draining liquid waste contained in a tank truck into said treatment container.

5. A waste treatment system as defined in claim 1, wherein said screen box has a mesh size small enough to prevent larger solids and other unwanted debris from entering the treatment container while not slowing the gravity filling of liquid waste from a tank truck into the treatment container.

6. A waste treatment system as defined in claim 1, additionally comprising:
a pump for conveying solids and sludge removed from said treatment container by said auger through a sludge delivery line to a location where the solids and sludge can be processed.

7. A waste treatment system as defined in claim 1, additionally comprising:
at least one additional outlet located in a side of said treatment container at a level above the level of said auger through which liquid waste contained in said treatment container can be removed for further processing, said at least one additional outlet being at a different level from said outlet, wherein said waste treatment system is arranged and configured to selectively transfer liquid waste from said treatment box from a selected one of said outlet and said at least one additional outlet to said at least one contaminant removal reactor.

8. A waste treatment system as defined in claim 1, additionally comprising:
at least one additional contaminant removal reactor.

9. A waste treatment system as defined in claim 8, additionally comprising:
a distribution system for selectively, automatically transferring liquid waste contained in said treatment container from said outlet to a selected one of said at least one contaminant removal reactor and said at least one additional contaminant removal reactor.

10. A waste treatment system as defined in claim 8, additionally comprising:
a plurality of chemical storage containers each for containing a chemical that may be used in processing liquid waste;
a chemical distribution system for selectively transferring a desired amount of chemicals contained in any one or more of said plurality of chemical storage containers to a selected one of said at least one contaminant removal reactor and said at least one additional contaminant removal reactor.

11. A waste treatment system as defined in claim 8, additionally comprising:
a decant distribution system for selectively, automatically transferring liquid waste contained in one of said at least one contaminant removal reactor and said at least one additional contaminant removal reactor to the other of said at least one contaminant removal reactor and said at least one additional contaminant removal reactor.

12. A waste treatment system as defined in claim 11, wherein said decant distribution system is also capable of selectively, automatically transferring liquid waste contained in one of said at least one contaminant removal reactor and said at least one additional contaminant removal reactor to a treated waste water disposal facility such as a public sewer.

13. A waste treatment system as defined in claim 8, additionally comprising:
a sludge distribution system for selectively, automatically transferring sludge contained in one of said at least one contaminant removal reactor and said at least one additional contaminant removal reactor to a sludge disposal facility.

14. A waste treatment system as defined in claim 13, wherein said sludge distribution system is also capable of selectively, automatically transferring sludge contained in one of said at least one contaminant removal reactor and said at least one additional contaminant removal reactor to the other of said at least one contaminant removal reactor and said at least one additional contaminant removal reactor.

15. A waste treatment system as defined in claim 1, additionally comprising:
a first outlet located in a side of said at least one contaminant removal reactor for removing liquid waste processed in said at least one contaminant removal reactor, said first outlet being located at a first selected level above the bottom of said at least one contaminant removal reactor; and
a second outlet located in a side of said at least one contaminant removal reactor for removing liquid waste processed in said at least one contaminant removal reactor, said second outlet being located at a second selected level above the bottom of said at least one contaminant removal reactor that is different from said first level.

16. A waste treatment system as defined in claim 15, additionally comprising:
a decant selection system for selectively transferring processed liquid waste contained in said at least one contaminant removal reactor from said at least one contaminant removal reactor through a selected one of said first and second outlets.

17. A waste treatment system as defined in claim 15, additionally comprising:
a first decant tap line having an inlet connected to said first outlet, said first decant tap line having a first valve contained therein for allowing the sampling of processed liquid waste contained in said at least one contaminant removal reactor from said first outlet through an outlet in said first decant tap line; and
a second decant tap line having an inlet connected to said second outlet, said second decant tap line having a second valve contained therein for allowing the sampling of processed liquid waste contained in said at least one contaminant removal reactor from said second outlet through an outlet in said second decant tap line.

18. A waste treatment system for treating inorganic liquid waste, said system comprising:
a treatment container for receiving liquid waste unloaded from a tank truck, said treatment container having sides and a bottom, wherein said treatment container has a cross-sectional configuration that tapers to a narrower width at said bottom thereof to direct heavier solids not filtered out by said screen box and sludge to a location near said bottom of said treatment container;
a screen box located in said treatment container for filtering out larger solids as the liquid waste is unloaded from a tank truck into said treatment container;
an auger located in said bottom of said treatment container, said auger being operable to remove accumulated heavier solids not filtered out by said screen box and sludge from said treatment container;
an outlet located in a side of said treatment container at a level above the level of said auger through which liquid waste contained in said treatment container can be removed for further processing;
first and second contaminant removal reactors for receiving liquid waste removed from said treatment container and for treating the liquid waste therein;
a distribution system for selectively, automatically transferring liquid waste contained in said treatment container from said outlet to a selected one of said first and second contaminant removal reactors;
a plurality of chemical storage containers each for containing a chemical that may be used in processing liquid waste;
a chemical distribution system for selectively transferring a desired amount of chemicals contained in any one or more of said plurality of chemical storage containers to a selected one of said at least one contaminant removal reactor and said at least one additional contaminant removal reactor; and
a decant distribution system for selectively, automatically transferring processed liquid waste contained in one of said first and second contaminant removal reactors to the other of said first and second contaminant removal reactors or to a treated waste water disposal facility such as a public sewer.

19. A waste treatment system for treating inorganic liquid waste, said system comprising:
a treatment container for receiving liquid waste unloaded from a tank truck, said treatment container having sides and a bottom;
a screen box located in said treatment container for filtering out larger solids as the liquid waste is unloaded from a tank truck into said treatment container;
an auger located in said bottom of said treatment container, said treatment container being arranged and configured such that heavier solids not filtered out by said screen box are directed to a location near said auger in said bottom of said treatment container as they are acted upon by gravity, said auger being operable to remove accumulated solids and sludge from said treatment container; and
a first outlet located in a side of said treatment container at a level above the level of said auger through which liquid waste contained in said treatment container can be removed for further processing.

20. A method for treating inorganic liquid waste, said method comprising:
unloading liquid waste from a tank truck or the like into a treatment container having sides and a bottom;
filtering out larger solids with a screen box located in said treatment container as the liquid waste is unloaded from a tank truck or the like into said treatment container;
directing heavier solids not filtered out by said screen box and sludge to a location near an auger located in said bottom of said treatment container as they are acted upon by gravity;
removing liquid waste contained in said treatment container be for further processing through an outlet located in a side of said treatment container at a level above the level of said auger;
receiving liquid waste removed from said treatment container in at least one contaminant removal reactor and treating the liquid waste in said at least one contaminant removal reactor; and
periodically operating said auger to remove accumulated solids and sludge from said treatment container.
